(19) United States
(12) Patent Application Publication
(10) Pub. No.: US 2026/0117824 A1
(43) Pub. Date: Apr. 30, 2026

(54) LOW-FRICTION SEALING DEVICE AND ASSOCIATED ROLLING BEARING

(71) Applicant: AKTIEBOLAGET SKF, GOTEBORG (SE)

(72) Inventors: Riccardo NARDICCHIA, Torino (IT); Mauro ROMANO, Prizzi (IT)

(21) Appl. No.: 19/359,782

(22) Filed: Oct. 16, 2025

(30) Foreign Application Priority Data
Oct. 24, 2024 (IT) 102024000023811

(51) Int. Cl. F16C 33/78; F16C 19/18

(52) U.S. Cl. CPC F16C 33/7823; F16C 19/183; F16C 2326/02

(57) ABSTRACT

A sealing device (1) for a rolling bearing (2) includes a first annular shield (21) mounted on a radially inner ring (4) of the rolling bearing, a second annular shield (22) mounted on a radially outer ring (5) of the rolling bearing, at least one elastomeric sealing element (23) and a substantially sleeve-shaped, annular, static sealing element (26) interposed between the first annular shield (21) and the radially inner ring (4) and mating in a fluid-tight manner with a constant velocity joint (14). The annular sealing element (26) has at least one groove (29) provided on a radially interior side of a side wall (28) and forms a channel (30) for direct hydraulic communication between an annular compartment (7) bounded between the inner ring and outer ring (4,5) and an empty inner volume (33) of the annular static sealing element (26).

### CROSS-REFERENCE TO RELATED APPLICATION

This application claims priority to Italian patent application no. 102024000023811 filed on Oct. 24, 2024, the contents of which are fully incorporated herein by reference.

### TECHNICAL FIELD

The present invention relates to a low-friction sealing device designed in particular for use in a wheel hub unit for a vehicle drive wheel, which is configured to be coupled, during use, with a constant velocity joint. The present invention also relates to a rolling bearing equipped with such a sealing device and designed to improve the efficiency thereof.

### BACKGROUND ART

A rolling bearing, which is designed for use in a wheel hub unit (hub bearing unit) for vehicles, typically comprises an inner ring that rotates during use, and an outer ring that remains stationary during use.

During use, a vehicle wheel is fixedly attached to the inner ring of the wheel hub unit either directly (via a first attachment flange formed integrally as one piece therewith) or indirectly (via one or more intermediate elements). On the other hand, the outer ring of the wheel hub unit is usually fixedly attached to a vehicle suspension upright, for example via a second radial attachment flange that is integrally formed as one piece therewith. A radial annular space is defined between the inner ring and the outer ring and houses the rolling bodies (for example, balls), which are designed to make the inner ring and the outer ring freely rotatable relative to each other about a common axis of symmetry.

In order to protect the rolling bodies from contaminants outside of the annular compartment, such as water, dust and mud, sealing devices are inserted between the inner ring and the outer ring.

In use, the wheel hub unit can be coupled with a constant velocity joint. In this case, the wheel hub unit forms, together with the constant velocity joint, an assembly that is completely sealed by sealing devices, which are respectively arranged both on an outboard side (outer side of the vehicle) and inboard side (inner side of the vehicle) of the wheel hub unit and/or of the rolling bearing which forms part thereof and/or which basically constitutes it. The inboard side sealing device also must be able to seal in a fluid-tight manner a grooved coupling between the constant velocity joint and the inner ring or spindle of the rolling bearing.

When the rolling bearing of the wheel hub unit is assembled at a location which is at a relatively low atmospheric pressure (for example, in a factory located at high altitude), but is then tested or used in a vehicle at a different location having different higher pressure conditions (for example, at an altitude lower than that in which the rolling bearing was assembled, or vice versa), a negative or positive pressure will prevail inside the assembled bearing/wheel hub unit, as compared to the ambient pressure.

This difference in pressure between the internal volume of the rolling bearing and the external atmosphere may lead to numerous drawbacks. For example, a negative pressure may result in greater friction and wear of the sealing lips of the seals that form a portion of the sealing device owing to the greater contact force exerted on the sliding-contact sealing lips by the atmospheric pressure (which is greater than the internal pressure of the rolling bearing). The opposite (i.e. positive pressure) condition may instead result in an undesirable lightening (reduction) of the contact pressure of the sliding-contact lips, with a consequent reduction or loss of sealing capacity (sealing performance).

DE 10 2018 123 126 A1 attempts to solve this problem by arranging (placing) a plastic ring (15) between the seat for the sealing device on the outer or inner ring and the respective sealing portion thereof. The plastic ring is permeable to air but is impermeable to moisture.

DE 10 2018 121 469 A1 instead proposes a ventilation means (11) that is mounted across one of the components of the sealing device. Such ventilation means generally consists of a valve provided with a semi-permeable membrane (13).

US 2022/065290 A1 even envisages performing the assembly of the wheel hub unit in a sealed chamber.

All these known solutions are in general complex, costly and not efficient; moreover, additional elements or several process steps, such as assembly in a sealed chamber, are required.

### SUMMARY

It is therefore one non-limiting object of the present teachings to disclose techniques for improving a sealing device for a rolling bearing and a rolling bearing for a wheel hub assembly, equipped with such a sealing device, that can avoid the drawbacks of the prior art and preferably are able to obtain, without any increase in axial or radial dimensions and/or without the use of additional elements, a hydraulic sealing action that is independent of possible variations in pressure between the location at which the wheel hub unit is assembled and the location at which a transmission group containing the wheel hub unit and a constant velocity joint coupled thereto is assembled.

In one non-limiting aspect of the present teachings, a sealing device (1) for a rolling bearing (2) preferably comprises a first annular shield (21) configured to be attached, in an angularly integral manner during use, to a component (12) of a radially inner ring (4) of the rolling bearing. A second annular shield (22) is preferably configured to be attached, in (at) an angularly integral manner during use, to a radially outer ring (5) of the rolling bearing, in a position facing the first annular shield. At least one elastomeric sealing element (23) is preferably formed integrally as one piece with the second annular shield (22) and includes at least one elastically deformable first annular sealing lip (24) that cooperates, in interference (sliding) contact, with a slide-contact surface (25) of the first annular shield (21). An annular static sealing element (26) is at least substantially sleeve-shaped and is preferably configured to be interposed during use between the first annular shield (21) and the radially inner ring (4) of the rolling bearing. Furthermore, the annular static sealing element (26) is preferably configured to mate with (be attached to or be mounted on) a radially outer side of a constant velocity joint (14) in a fluid-tight manner. The annular static sealing element (26) preferably extends in an axially projecting manner from a first face (27) of the first annular shield (21), which is opposite the second annular shield (22) and faces the constant velocity joint during use. A radially inward side of a side wall (28) of the annular sealing element (26) is preferably provided with at least one groove (29) configured to form a hydraulic communication channel (30) to permit hydraulic communication between a first surrounding volume (31) adjacent to a first front face (32) of the second annular shield (22), which is opposite to the first annular shield and the elastomeric sealing element (23), and an empty inner volume (33) of the annular static sealing element (26) bounded by the side wall (28) thereof. The groove (29) preferably extends axially (in the axial direction) beyond the elastomeric sealing element (23) on the side of the first front face (32) of the second annular shield (22).

### BRIEF DESCRIPTION OF THE DRAWINGS

Further characteristic features and advantages of the present teachings will become clear from the following description of two non-limiting embodiments thereof, provided with reference to the attached drawings, in which:

FIG. 1 shows in schematic form a radially sectioned longitudinal view of a transmission group for vehicles, composed of a wheel hub unit and a constant velocity joint, the wheel hub unit being provided with or containing of a rolling bearing according to the present teachings.

FIG. 2 shows in schematic form details of FIG. 1 in an enlarged scale, with the constant velocity joint omitted.

FIG. 3 shows in schematic form details of a first embodiment of a sealing device according to the present teachings in an enlarged scale.

FIG. 4 shows in schematic form the same details as shown in FIG. 2 in an enlarged scale, but realized in accordance with a different embodiment of the sealing device according to the present teachings, with the constant velocity joint in the coupled position.

FIGS. 5 and 6 respectively show the same details as shown in FIG. 2 in an enlarged scale, but realized in accordance with two possible embodiments of the sealing device according to the present teachings, respectively.

### DETAILED DESCRIPTION OF THE INVENTION

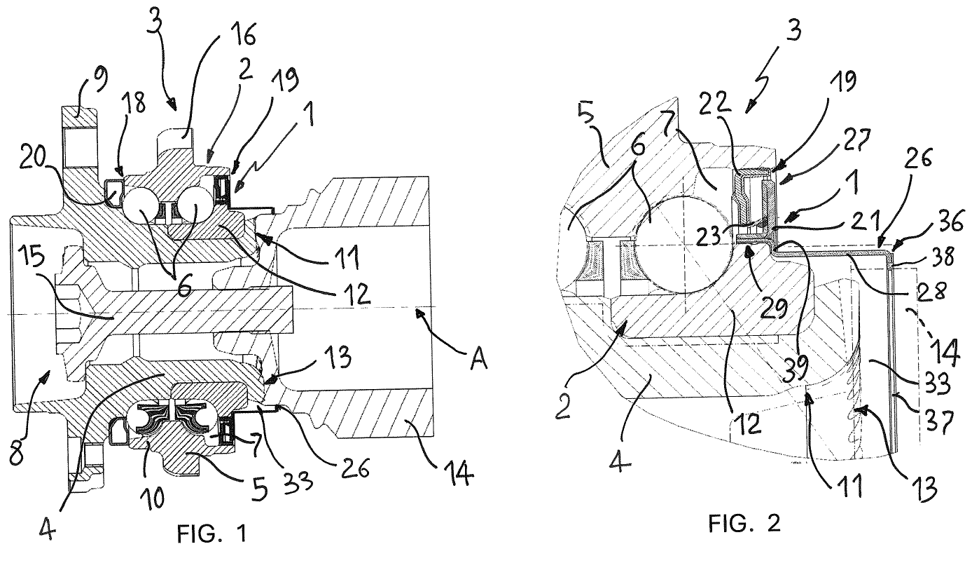

With reference to FIGS. 1 and 2, reference number 1 denotes overall a sealing device for a rolling bearing 2, in particular configured to form part of, or constitute per se, a wheel hub unit or assembly of a generally known type.

The rolling bearing 2 comprises an inner ring 4, which rotates during use, an outer ring 5, which is stationary during use, and a plurality of rolling bodies (rolling elements, e.g., balls) 6 housed in a radial annular space (radial annular compartment) 7 bounded between the inner ring 4 and the outer ring 5, so that the inner ring 4 and the outer ring 5 are freely rotatable relative to each other about a common axis of symmetry A.

In the non-limiting example of the present teachings shown in FIG. 1, at a first axial end 8 of the inner ring 4, a radial flange 9 extends in a radially projecting manner from the inner ring 4 radially outward and faces a corresponding first axial end 10 of the outer ring 5.

The inner ring 4 also has, in the non-limiting example shown in FIG. 1, a second axial end 11 that is opposite the first axial end 8, and on which a mounting ring or “ring-piece” 12, which forms an integral part of the inner ring 4, is integrally assembled. Because the present teachings are applicable in particular to a wheel hub assembly/unit 3 intended for a vehicle drive wheel, the second axial end 11 is provided with a torque transmission device such as a grooved coupling 13, which in the non-limiting example shown is a frontal or SFS type. The grooved coupling mates (see FIG. 1) with a constant velocity joint 14, of a known type—only the external bell member of which is shown for simpler illustration-against which it is retained, during use, in a stably (securely) coupled manner by a screw 15.

On the other hand, on the opposite side to the first axial end 10, the outer ring 5 is provided, integrally as one piece, with a radial flange 16 that extends radially outward and that is configured to be fixed, integrally during use, to a vehicle suspension upright, which is known and not shown for simpler illustration. In FIG. 2, the constant velocity joint (“CVJ”) 14 is shown as a thin broken line.

Basically, the rolling bearing 2 shown in FIGS. 1 and 2 is of the so-called “third generation” or “double-flange” type and itself forms the entire wheel hub unit 3. It is clear, however, that the wheel hub assembly or unit 3 could comprise, according to other non-limiting examples of the present teachings (which are not shown), a normal known hub and spindle which is provided with the flange 9 and on which the inner ring 4 is coupled in a known manner, without affecting the general nature of the description provided below. Similarly, the outer ring 5 could omit the flange 14 and be configured to be mounted in (on) the suspension upright 15, in a known manner.

The annular radial space (annular radial compartment) 7 has open opposite axial ends 18 and 19 (FIG. 1), which are sealed during use in a fluid-tight manner by opposite sealing devices. For example, the axial end 18 may be sealed by any known sealing device 20 (shown only schematically in FIG. 1) and the axial end 19 is preferably sealed by a sealing device 1 according to the present teachings.

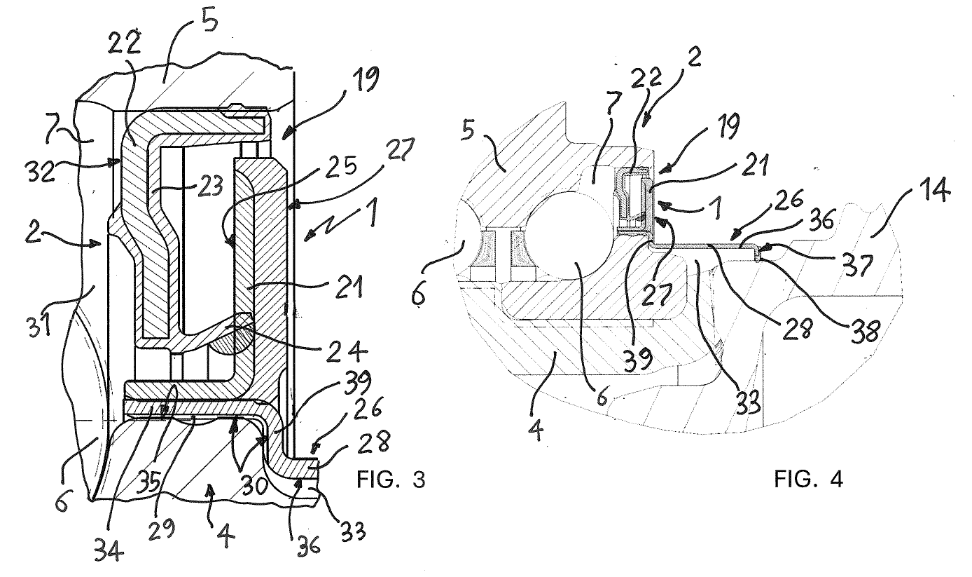

Referring now to FIGS. 2 to 6, the sealing device 1 comprises a first annular shield 21 configured to be attached in an angularly integral manner during use, in a known manner, for example by a form-fit, to a portion or component of the radially inner ring 4 of the rolling bearing 2, In the present example, it is attached to the ring-piece 12. Furthermore, the sealing device 1 also comprises a second annular shield 22 configured to be attached in an angularly integral manner during use to the radially outer ring 5 of the rolling bearing 2, in (at) a position facing the first annular shield 21. In addition, at least one elastomeric sealing element 23 is formed integrally as one piece with the second annular shield 22 and is provided with at least one elastically deformable first annular sealing lip 24 (see FIG. 3) that cooperates, in interference (sliding) contact, with a sliding/sliding-contact surface 25 of the first annular shield 21. In the drawings, the annular lip 24 is shown in the undeformed state so as to highlight (in a purely schematic manner) the assembly interference with the surface 25.

According to one aspect of the present teachings, the sealing device 1 also preferably comprises an annular static sealing element 26 that is shaped substantially as a sleeve and is configured to be interposed, during use, between the first annular shield 21 and the radially inner ring 4 (in the present example, the ring-piece 12) of the rolling bearing 2 and to mate in a fluid-tight manner with a radially outer surface of the constant velocity joint 14.

The first and second annular shields 21, 22 have a common axis of symmetry A coinciding, during use, with the axis of symmetry of the inner ring 4 and the outer ring 5 of the rolling bearing 2.

The annular static sealing element 26 extends in an axially projecting manner from a first front face 27 of the first annular shield 21, opposite the second annular shield 22, and faces the constant velocity joint 14 during use.

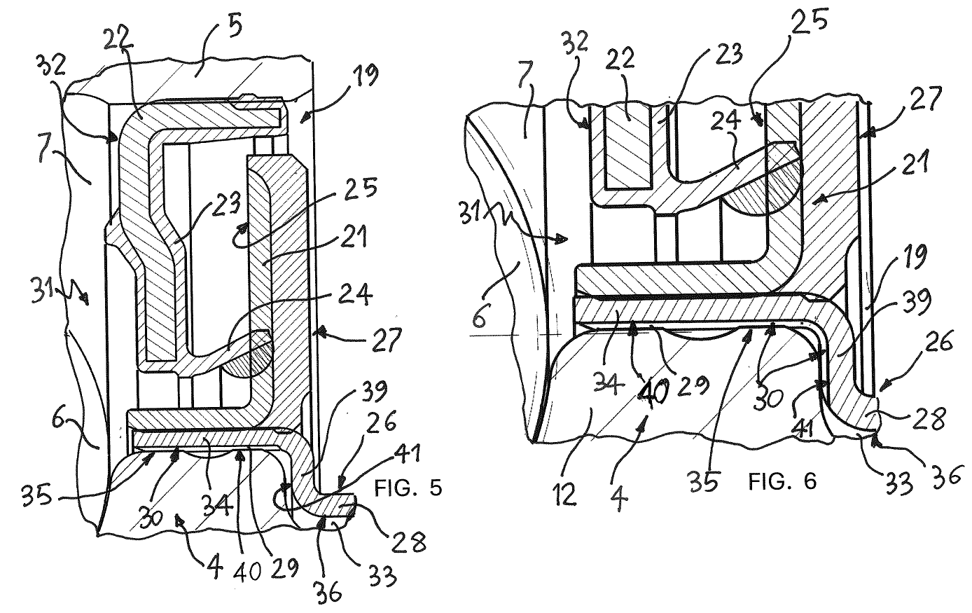

On the radially inward side of a side wall 28 of the annular static sealing element 26, at least one groove 29 (see FIGS. 3, 5 and 6) is provided and is preferably configured to form a hydraulic communication channel (fluid communication channel) 30 (see FIGS. 5 and 6) between a first surrounding volume 31 adjacent to a first front face 32 of the second annular shield 22, opposite to the first annular shield 21 and the elastomeric sealing element 23, coinciding in the example shown with the inner volume which is free (of the balls 6) of the radial compartment 7, and an empty inner volume 33 of the annular static sealing element 26, which is bounded (delimited) all around by the side wall 28.

The groove 29 extends axially (in the axial direction of the rolling bearing 2) beyond the elastomeric sealing element 23 (and all its sealing lips such as the lip 24) on the side of the first face 32 of the second annular shield 22.

As mentioned above, the first surrounding volume 31 is defined, during use, by the interior of the rolling bearing 2 since the sealing device 1, during use, is interposed between the inner ring 4 and the outer ring 5 of the rolling bearing 2 so as to close the radial annular volume (compartment) 7 bounded (delimited) between (by) the inner ring 4 and outer ring 5 of the rolling bearing 2.

The groove 29 is also configured to be, during use, in direct hydraulic (fluid) communication with the radial annular compartment 7.

The empty inner volume 33 of the annular sealing element 26 is also configured to receive during use, inside it, the constant velocity joint 14.

According to preferred embodiments of the present teachings, the side wall 28 of the annular sealing element 26 comprises a first cylindrical annular portion 34 configured to mate in an angularly integral manner, during use, with a radially outer side surface 35 of the inner ring 4 (ring-piece 12) of the rolling bearing 2.

The side wall 28 of the annular sealing element 26 also comprises a second annular portion 36, opposite to the first annular portion 34 and extending in an axially projecting manner from the first cylindrical annular portion 34 and terminating in (at) an annular rim 37, which has, mounted thereon, an annular seal 38 (FIG. 4) configured to cooperate in a fluid-tight manner, during use, radially outward of the constant velocity joint 14.

The first annular shield 21 is mounted radially outward of the annular sealing element 26, more specifically on the first cylindrical annular portion 34, which is in turn mounted, with a form fit, radially on the outside of the inner ring 4, as already explained above.

The first cylindrical annular portion 34 of the annular sealing element 26 has a diameter greater than a maximum radial extension of the second cylindrical annular portion 36 of the annular sealing element 26.

In the examples shown, the second annular portion 36 of the annular sealing element 26 is also cylindrical and has a diameter smaller than the diameter of the first annular portion 34 of the annular sealing element 26.

The annular sealing element 26, apart from the elastomeric seal 38 mounted integrally on the annular rim 37, is made of a metallic or in any case relatively rigid, but elastically deformable material, so that the elastomeric seal 38 may cooperate with the constant velocity joint 14 with a minimum amount of interference.

The second annular portion 36 of the annular sealing element 26 extends in an axially projecting manner from a radially oriented (radially-extending) intermediate flange portion 39 of the annular sealing element 26, which connects together the first and second annular portions 34, 36 of the annular sealing element 26.

According to the embodiment shown in FIG. 5, the at least one groove 29, which is configured to form the hydraulic communication channel 30, extends axially over (across) the entire cylindrical inner side surface 40 of the first annular portion 34 of the annular sealing element 26.

In a second embodiment shown in FIG. 6, the at least one groove 29, which is configured to form a hydraulic communication channel 30, extends not only axially over the entire axial extension of the radially inner surface 40 of the cylindrical portion 34, but also extends radially, with continuity, with its axial portion and with the cylindrical inner side surface 40 also over a face 41 of the radial flange portion 39 of the annular sealing element 26 that faces the first annular portion 34 thereof.

According to this second embodiment, in fact, the second face 41 cooperates in abutment against the inner ring 4, in the case in question against an annular step-shaped end defined by the ring-piece 12, which acts as an end-of-travel stop of the coupling of the sealing element 26 and the inner ring 4. On the other hand, in the first embodiment shown in FIG. 5, the face 41 faces, but is axially spaced from, the aforementioned step-shaped end defined by the ring-piece 12.

In both embodiments, therefore, continuity of the hydraulic connection between the compartment 7 and the inner volume 33 of the axial annular portion 36 of the sealing element 26 is ensured.

The at least one groove 29 configured to form the hydraulic communication channel 30 is preferably formed by plastic deformation stamping, during the formation, by means of moulding, of the annular sealing element 26.

The (axial portion of the) at least one groove 29 preferably has two characteristic parameters:
the axial length is greater than the axial length of the counter-face portion of the ring-piece 12 on which the annular axial portion 34 is mounted; and
the (circumferential) cross-sectional area, which is measured with the static sealing element 26 mounted on the ring-piece 12, is greater than 0.0025 mm² (equivalent to a square cross-section having the dimensions of 50 μm×50 μm).

In the case of the embodiment shown in FIG. 6, the groove 29 continues, still with the area of its cross-section greater than 0.0025 mm², beyond the axial extension of the annular portion 34 and across the abutment zone formed by the face 41, until it reaches the inner volume 33 and, consequently, the constant velocity joint 14 is not yet coupled with the wheel hub unit 3 and communicates with the external surrounding atmosphere.

From the description above, it is clear that the embodiments of the present teachings also include a rolling bearing 2 for a wheel hub unit 3, which comprises an inner ring 4 that rotates during use, an outer ring that is stationary during use, and a plurality of rolling bodies (elements) 6 housed in a radial annular space (compartment) 7 bounded (delimited) between (by) the inner ring 4 and the outer ring 5 so as to make the inner ring 4 and the outer ring 5 freely rotatable relative to each other about a common axis of symmetry A. A first open end 19 of the radial annular compartment 7 is closed by a sealing device as described further above or below. Furthermore, the at least one groove 29 is formed on the radially interior side of the side wall 28 of the annular static sealing element 26 and is configured to form a hydraulic (fluid) communication channel 30 that permits (enables) direct hydraulic (fluid) communication between the radial annular compartment 7 and the empty inner volume 33 of the annular static sealing element 26 bounded by the second annular portion 36, radially on the inside thereof. Consequently, when the constant velocity joint 14 is uncoupled, the empty inner volume 33 communicates with the external surrounding atmosphere.

Embodiments of the present teachings preferably also include an assembly of a wheel hub unit 3 and a constant velocity joint 14 that comprises a rolling bearing 2, as described above or below, which forms a portion of or constitutes the wheel hub unit 3, and a sealing device 1 in accordance with the description above or below, which is arranged (disposed) so as to close off an end 19 of the radial annular compartment 7 bounded between the outer ring 5 and inner ring 4 of the rolling bearing 2 and facing the constant velocity joint 1. The at least one groove 29, which is defined on the radially interior side of the side wall 28 of the annular static sealing element 26 forms a channel 30 for direct hydraulic communication between the radial annular compartment 7 and the interior of the second annular portion 36 of the annular static sealing element 26.

This second annular portion 36 is therefore open for communication with the external environment when the constant velocity joint 14 is not yet mounted, allowing the pressure of the air inside the compartment 7, owing to the channel 30, to be kept identical to the external atmospheric pressure, in whatever location that assembly of the rolling bearing 2 or the wheel hub unit 3 is performed.

Vice versa, once the constant velocity joint 14 is coupled with the wheel hub unit 3, the radial annular compartment 7 is isolated (blocked, sealed) from the external atmosphere owing to the static sealing action exerted by the sealing element 26 by the annular seal 38, wherein the second annular portion 36, during use, is fitted in a fluid-tight manner radially onto the outside of the constant velocity joint 14.

Thus, sealing devices according to the present teachings provide the advantage of being able to enable pressure equalization between the inner space of the rolling bearing and the external space without requiring an increase in radial and/or axial dimensions and/or without the use of additional components.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A sealing device for a rolling bearing, comprising:
a first annular shield configured to be attached, in an angularly integral manner during use, to a component of a radially inner ring of the rolling bearing,
a second annular shield configured to be attached, in an angularly integral manner during use, to a radially outer ring of the rolling bearing, in a position facing the first annular shield,
at least one elastomeric sealing element formed integrally as one piece with the second annular shield and having at least one elastically deformable first annular sealing lip that cooperates in interference contact with a slide-contact surface of the first annular shield, and
an annular static sealing element that is at least substantially sleeve-shaped and is configured to be interposed during use between the first annular shield and the radially inner ring of the rolling bearing and to mate in a fluid-tight manner with a radially outer side of a constant velocity joint,
wherein:
the annular static sealing element extends in an axially projecting manner from a first face of the first annular shield, which is opposite the second annular shield and is configured to face the constant velocity joint during use,
on a radially inward side of a side wall of the annular sealing element, at least one groove is defined and is configured to form a hydraulic communication channel that permits hydraulic communication between a first surrounding volume adjacent to a first front face of the second annular shield, which is opposite to the first annular shield and the elastomeric sealing element, and an empty inner volume of the annular static sealing element bounded by the side wall of the annular sealing element, and
the groove extends axially beyond the elastomeric sealing element on the side of the first face of the second annular shield.

2. The sealing device according to claim 1, wherein:
the first surrounding volume is defined during use by an interior of the rolling bearing,
the sealing device is configured to be interposed during use between the inner ring and the outer ring of the rolling bearing so as to close off a radial annular compartment bounded between the inner ring and the outer ring of the rolling bearing, and
the groove is configured to be in hydraulic communication with the radial annular compartment during use.

3. The sealing device according to claim 1, wherein the empty inner volume of the annular static sealing element is configured to receive during use, within it, the constant velocity joint.

4. The sealing device according to claim 1, wherein the side wall of the annular sealing element comprises:
a first cylindrical annular portion configured to mate, in an angularly integral manner during use, with a radially outer side surface of the inner ring of the rolling bearing, and
a second annular portion that is opposite to the first annular portion, extends in an axially projecting manner from the first cylindrical annular portion and terminates at an annular rim with an annular seal configured to cooperate in a fluid-tight manner, during use, with the radially outer side of the constant velocity joint,
wherein the first cylindrical annular portion of the first annular shield is mounted on the radially exterior side of the annular static sealing element.

5. The sealing device according to claim 4, wherein:
the first cylindrical annular portion of the annular sealing element has a diameter greater than a radial extension of the second annular portion of the annular sealing element, and
the annular sealing element extends in an axially projecting manner from a radially oriented flange portion of the annular sealing element, which connects together the first and second annular portions of the annular sealing element.

6. The sealing device according to claim 5, wherein the at least one groove configured to form the hydraulic communication channel extends axially across the entirety of a cylindrical inner side surface of the first annular portion of the annular sealing element.

7. The sealing device according to claim 6, wherein the at least one groove configured to form the hydraulic communication channel extends in a radial direction continuously with the cylindrical inner side surface of the first annular portion also on a face of a radial flange portion of the annular sealing element that faces the first annular portion of the annular sealing element.

8. The sealing device according to claim 4, wherein:
the second annular portion of the annular sealing element is cylindrical and has a diameter smaller than the diameter of the first annular portion of the annular static sealing element,
the first annular portion is made of a metallic or otherwise relatively rigid, but elastically deformable material, and
the at least one groove configured to form the hydraulic communication channel is formed by plastic deformation stamping.

9. A rolling bearing for a wheel hub unit, comprising:
an inner ring that is configured to be rotatable during use,
an outer ring that is configured to be stationary relative to the inner ring during use, and
a plurality of rolling bodies housed in a radial annular compartment bounded between the inner ring and the outer ring so as to make the inner ring and the outer ring freely rotatable relative to each other about a common axis of symmetry,
wherein:
a first open end of the radial annular compartment is closed by the sealing device according to claim 4,
the at least one groove is configured to form the hydraulic communication channel for direct hydraulic communication between the radial annular compartment and the empty inner volume of the annular sealing element, and
the annular sealing element is bounded by the second annular portion of the side wall of the annular sealing element and is disposed radially therein.

10. An assembly of a wheel hub unit and constant velocity joint, wherein:
the rolling bearing according to claim 9 forms at least a portion of the wheel hub unit,
the sealing device is arranged to close the first open end of the radial annular compartment bounded between the outer ring and the inner ring of the rolling bearing and faces the constant velocity joint,
the at least one groove defined on the radially interior side of the side wall of the annular sealing element defines the hydraulic communication channel that permits direct hydraulic communication between the radial annular compartment and the interior of the second annular portion of the annular sealing element, and
the second annular portion is fitted in a fluid-tight manner onto the radially outer side of the constant velocity joint.

11. The sealing device according to claim 2, wherein the empty inner volume of the annular static sealing element is configured to receive during use, within it, the constant velocity joint.

12. The sealing device according to claim 11, wherein the side wall of the annular sealing element comprises:
a first cylindrical annular portion configured to mate, in an angularly integral manner during use, with a radially outer side surface of the inner ring of the rolling bearing, and
a second annular portion that is opposite to the first annular portion, extends in an axially projecting manner from the first cylindrical annular portion and terminates at an annular rim with an annular seal configured to cooperate in a fluid-tight manner, during use, the radially outer side of the constant velocity joint,
wherein the first cylindrical annular portion of the first annular shield is mounted on the radially exterior side of the annular static sealing element.

13. The sealing device according to claim 12, wherein:
the first cylindrical annular portion of the annular sealing element has a diameter greater than a radial extension of the second annular portion of the annular sealing element, and
the annular sealing element extends in an axially projecting manner from a radially oriented flange portion of the annular sealing element, which connects together the first and second annular portions of the annular sealing element.

14. The sealing device according to claim 13, wherein the at least one groove configured to form the hydraulic communication channel extends axially across the entirety of a cylindrical inner side surface of the first annular portion of the annular sealing element.

15. The sealing device according to claim 14, wherein the at least one groove configured to form the hydraulic communication channel extends in a radial direction continuously with the cylindrical inner side surface of the first annular portion also on a face of a radial flange portion of the annular sealing element that faces the first annular portion of the annular sealing element.

16. The sealing device according to claim 15, wherein:
the second annular portion of the annular sealing element is cylindrical and has a diameter smaller than the diameter of the first annular portion of the annular static sealing element,
the first annular portion is made of a metallic or otherwise relatively rigid, but elastically deformable material, and
the at least one groove configured to form the hydraulic communication channel is formed by plastic deformation stamping.

17. A rolling bearing for a wheel hub unit, comprising:
an inner ring that is configured to be rotatable during use,
an outer ring that is configured to be stationary relative to the inner ring during use, and
a plurality of rolling bodies housed in a radial annular compartment bounded between the inner ring and the outer ring so as to make the inner ring and the outer ring freely rotatable relative to each other about a common axis of symmetry,
wherein:
a first open end of the radial annular compartment is closed by the sealing device according to claim 16,
the at least one groove defines the hydraulic communication channel that permits direct hydraulic communication between the radial annular compartment and the empty inner volume of the annular sealing element, and
the annular sealing element is bounded by the second annular portion of the side wall of the annular sealing element and is disposed radially therein.

18. An assembly of a wheel hub unit and constant velocity joint, wherein:
the rolling bearing according to claim 17 forms at least a portion of the wheel hub unit,
the sealing device is arranged to close the first open end of the radial annular compartment bounded between the outer ring and the inner ring of the rolling bearing and faces the constant velocity joint,
the at least one groove defined on the radially interior side of the side wall of the annular sealing element defines the hydraulic communication channel that permits direct hydraulic communication between the radial annular compartment and the interior of the second annular portion of the annular sealing element, and
the second annular portion is fitted in a fluid-tight manner onto the radially outer side of the constant velocity joint.
